(19) United States
(12) Patent Application Publication
(10) Pub. No.: US 2013/0191517 A1
(43) Pub. Date: Jul. 25, 2013

(54) SYSTEM, SERVER AND METHOD FOR REPRODUCING TOPOLOGICAL CHANGE USING DEVICE EVENTS

(71) Applicants: Ming Hunag Ling, New Taipei City (TW); Ho Chin Yang, New Taipei City (TW); Chung Shih Chung, New Taipei City (TW); Che Min Su, New Taipei City (TW); Chih Hsien Liu, New Taipei City (TW); Jhih An Yan, New Taipei City (TW)

(72) Inventors: Ming Hunag Ling, New Taipei City (TW); Ho Chin Yang, New Taipei City (TW); Chung Shih Chung, New Taipei City (TW); Che Min Su, New Taipei City (TW); Chih Hsien Liu, New Taipei City (TW); Jhih An Yan, New Taipei City (TW)

(73) Assignee: MOXA INC., New Taipei City (TW)

(21) Appl. No.: 13/354,345

(22) Filed: Jan. 20, 2012

(51) Int. Cl. G06F 15/177

(52) U.S. Cl. 709/220

(57) ABSTRACT

A system, a server and a method for reproducing topological change using device events are provided. Using a server to collect device messages of network devices in a network environment and after determining and producing a device event that includes reproducing data based on the collected device messages, the device event is sent to a reproducing client. The reproducing client updates and displays topological change in the network in accordance with the reproducing data in the device event. The system and the method can use a GUI to display topological change in the network, and achieve the effect of understanding the change in linking state of network devices in the network intuitively.

### BACKGROUND OF THE RELATED ART

1. Technical Field

The invention relates to a system, a server and the method for displaying network topological thereof. In particular, the invention relates to a system, a server and a method for reproducing topological change using device events.

2. Related Art

As the number of hosts in a usual network environment increases, it is getting difficult to purely rely on network administrators to manage the network. Therefore, some tools for managing networks are developed. Currently, the Simple Network Management Protocol (SNMP) has been widely used to manage networks. Therefore, almost all network devices such as hubs, switches, routers, and computers support the SNMP, so that network administrators can easily manage the entire network.

In network management tools currently available on the market, most provide the function of monitoring the operation states of network devices. Some of them even provide the function of recording device messages in order for the manager to know topological change in the network environment. However, the function of recording device messages is usually expressed in terms of text or tables. Suppose one network event occurs in a network environment. For example, some communication port of a network device breaks from a connection, the user of replay function of historical events has to learn slowly from the text or table displayed by the network management system. This is inconvenient for the user to understand topological change in the network environment.

In summary, the prior art always has the problem that it is difficult to understand topological change in a network environment from text or table. It is thus imperative to provide a solution.

### SUMMARY

In view of the foregoing, the invention provides a system for reproducing topological change using device events and the method thereof.

The disclosed server for reproducing topological change using device events includes: a network message collecting module for scanning a network environment consisting of a plurality of network devices and obtaining a scan result and for collecting device messages of the network devices; a topology building module for determining the linking states among the network devices according to the scan result; an event determining module for determining and producing a device event according to the device messages, the device event including event information and reproducing data generated according to the linking states; a database for recording the device events; a server transmission module for receiving a network state request sent from a reproducing client; a data searching module for searching for a corresponding device event according to the network state and sending the device event via the server transmission module to the client so that the reproducing client is able to update and display the topology of the network environment in a graphical user interface (GUI) at a specific frequency according to the device event.

The disclosed system of reproducing topological change using device events includes at least: a client transmission module for sending a network state request to a server and for receiving a device event returned from the server; a topology reproducing module for defining network topology of the network environment according to reproducing data in the device event, the network topology including the linking states among the network devices; and a displaying module for using a specific frequency to update and display the network topology in a GUI.

The disclosed method of reproducing topological change using device events includes the steps of: using a server to scan the network environment comprised of a plurality of network devices; using the server to determine the linking states among the network devices according to the scan result; using the server to collect device messages of the network devices; using the server to determine and produce a device event according to the device messages, the device event including event information thereof and reproducing data generated according to the linking states; using the server to record the device event; using the server to receive a network state request sent from the reproducing client; using the server to search for a corresponding device event according to the network state; using the server to send the device event to the reproducing client; defining the topology of the network environment according to the reproducing data in the device event by the reproducing client, the network topology including the linking states among the network devices; updating and displaying the network topology in a GUI at a specific frequency by the reproducing client.

The disclosed system and method differ from the prior art in that after the server determines and produces the device event containing the reproducing data according to the collected device messages, the device event is sent to the reproducing client. The topological change then updates and displays changes in the network topology of the network environment according to the device event. The invention thus solves the problems in the prior art and achieves the effect of enabling its user to intuitively under the linking states among the network devices.

### BRIEF DESCRIPTION OF THE DRAWINGS

The invention will become more fully understood from the detailed description given herein below illustration only, and thus is not limitative of the present invention, and wherein:

FIG. 1 is a schematic view of the disclosed network structure.

FIG. 2 is a schematic view of elements of the server for reproducing the topological change using device events.

FIG. 3 shows the system structure for reproducing the topological change using device events.

FIG. 4 shows the control panel according to an embodiment of the invention.

FIG. 5A is a flowchart of the disclosed method for reproducing the topological change using device events.

FIG. 5B is a flowchart of the appended method of storing the display attributes.

FIG. 5C is a flowchart of the detailed method of generating reproducing data.

FIG. 5D is a flowchart of the method of displaying the network topology filtered the device event.

FIG. 5E is a flowchart of another method of displaying the network topology filtered the device event.

FIG. 6A shows the network topology according to the embodiment of the invention.

FIG. 6B shows the updated network topology according to the embodiment of the invention.

FIG. 6C shows the device states according to the embodiment of the invention.

### DETAILED DESCRIPTION

The present invention will be apparent from the following detailed description, which proceeds with reference to the accompanying drawings, wherein the same references relate to the same elements.

The invention can collect device messages of all network devices in a network environment. Through a graphical user interface (GUI), the invention displays topological change in the network environment within a specific time in the past.

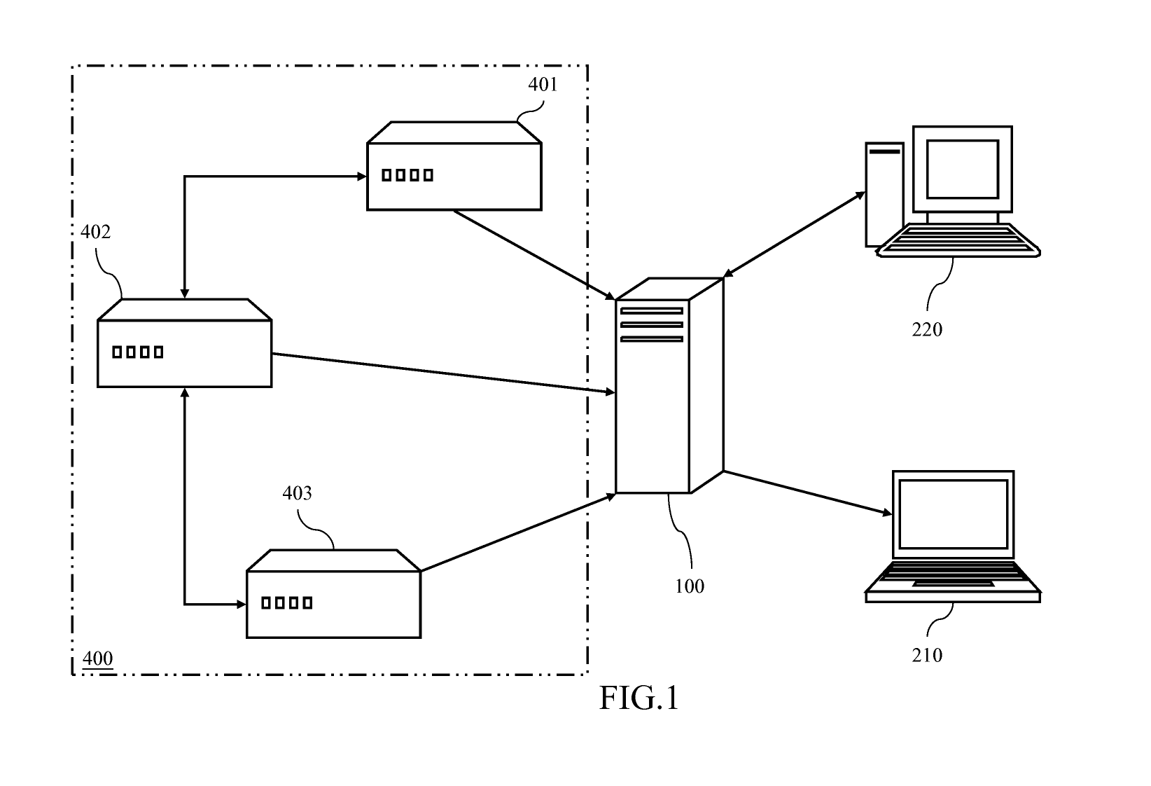

FIGS. 1, 2, and 3 are used to explain how the invention operates in the following paragraphs. As shown in the network structure in FIG. 1, the invention includes a server 100, a reproducing client 210, multiple network devices 401, 402, 403, etc.

FIG. 1 includes many network devices 401, 402, 403, etc., all of which constitute a network environment 400. Each of the network devices can send a device message concerning state changes to the server 100 using the Simple Network Management Protocol (SNMP) whenever its state changes.

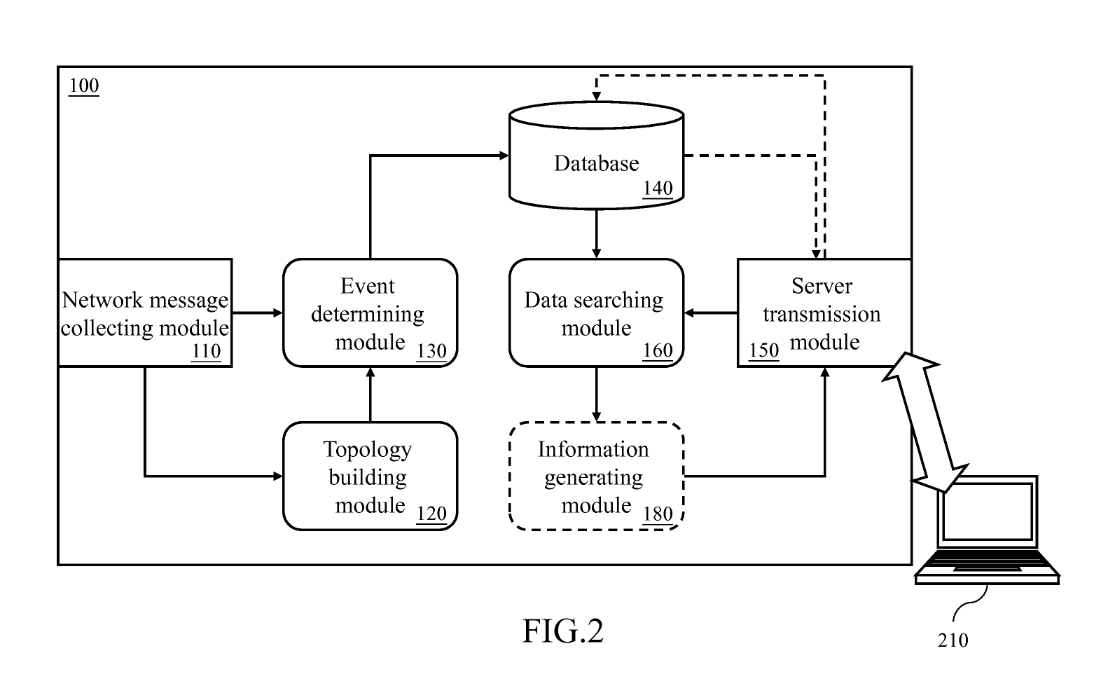

The server 100 is connected to the network environment 400. It collects the device messages of all network devices on the network environment 400, and produces a corresponding device event according to the received device messages. As shown in FIG. 2, the server 100 further includes a network message collecting module 110, a topology building module 120, an event determining module 130, a database 140, a server transmission module 150, and a data searching module 160.

The network message collecting module 110 scans the network environment 400, and determines the linking states of all network devices in the network environment 400 according to the scan result. Generally speaking, the network message collecting module 110 can use the Link Layer Discover Protocol (LLDP) to obtain the linking states of all network devices in the network environment 400. However, the invention is not limited to this possibility.

The network message collecting module 110 also collects the device messages of all the network devices in the network environment 400. The network message collecting module 110 can actively and periodically poll the network devices using a polling engine with the SNMP, thereby obtaining the device messages of the network devices. The device message collected using the polling engine includes: “Port Up/Down” that represents state change in a specific port of the network device, “Device Unreachable/Reachable” that represents whether the network device is reachable, flux of the network device, packet error information of the network device, or some other SNMP information. However, the invention is not limited to such possibilities.

The network message collecting module 110 can also passively receive device messages sent from the network devices using the SNMP using a message listener. In general, the network message collecting module 110 may simultaneously use both the active and passive methods or either method to collect the device messages of the network devices. The invention does not have any restriction on this. The device message collected by the message listener includes: “Port Up/Down” that represents state change in a specific port of the network device, “configuration has been changed” that represents setting changes in the network device, or device behavior such as the network device actively notifies about cold start, warm start, or power on/off. However, the invention is not limited to such possibilities.

The topology building module 120 determines and organizes the scan result obtained by the network message collecting module 110 after scanning the network environment 400, thereby obtaining the linking states among the network devices in the network environment 400.

The event determining module 130 determines according to the device message collected by the network message collecting module 110 whether it is necessary to produce a device event corresponding to the collected device message. In general, the event determining module 130 produces a device event only when the device message is “Port Up/Down” or “Device Unreachable/Reachable.” However, the invention is not limited to such possibilities.

The device event produced by the event determining module 130 includes event information and reproducing data. The event information represents the device event, and includes an event code, a network device code related to the device event, an event type, an event seriousness, an event time, the IP address of the network device that produces the device message, an event determining source, the port number of the network device, an event state (e.g., up/down or enable/disable), an actual value (e.g., load percentage), etc. However, the invention is not limited to such possibilities. The reproducing data include the data required reproducing the network state when the device message is produced. The reproducing data are generated according to the linking states of the network devices in the network environment 400 obtained by the topology building module 120 by the event determining module 130. The reproducing data can be the difference between the current device event and the last device event or the complete state information of the network environment 400. The reproducing data at least include network device states and network linking states. The network device state includes such basic data as a network device ID, a network device model, a network device named by the user, a network device location, a network device status, a network device IP address, a network device MAC address, a network device system ID, a network device redundancy setting, a network device polling frequency, a network device SNMP version, and other information retrieved by the SNMP. The network linking state includes a linking ID, a linking source, a linking target, a linking status, a port of the linking source, a port of the linking target, a linking redundancy setting, a linking speed, etc.

After the network message collecting module 110 collects the device message of “Port Up/Down,” the event determining module 130 determines the state change in a specific port of the network device that produces the device message of “Port Up/Down” according to the content thereof. The linking state of the network device is updated according to the state change in the port. Therefore, the event determining module 130 can generate new state information according to the updated linking state. For example, when the device message “Port Up/Down” represents that the primary port of a redundancy link connects/breaks, the event determining module 130 simultaneously updates the primary port of the redundancy link and the linking state of the backup port. When the device message “Port Up/Down” represents that the backup port of the redundancy link or the port of the usual link connects/breaks, the event determining module 130 updates the state of the backup port or the port of the usual link.

After the network message collecting module 110 collects the device message of “Device Unreachable/Reachable,” the event determining module 130 also determines from the contents recorded in the device message of “Device Unreachable/Reachable” that the network device that generates the device message of “Device Unreachable/Reachable” can/cannot function normally. It further updates the linking states of the other network devices connected with the network device that generates the device message of “Device Unreachable/Reachable” according to whether the network device can function normally. Therefore, the event determining module 130 can also generate new state information according to the updated linking states. For example, when the network message collecting module 110 collects the device message of “Device Unreachable” generated by some network device, the event determining module 130 can directly updates the link state between the network device generating “Device Unreachable” with the other network devices as connect. Or it can first determine whether the other network devices connected with the network device generating “Device Unreachable” function normally. If the other network devices function normally, then the link state between the network device generating “Device Unreachable” with the other normal network devices is set as break. When the network message collecting module 110 collects the device message of “Device Reachable” generated by some network device, the event determining module 130 can directly updates the link state between the network device generating “Device Reachable” and the other network devices as connect. Alternatively, the event determining module 130 can first determine whether the other network device connected with the network device generating “Device Reachable” is normally. If the other network device is normally, then the link state between the network device generating “Device Reachable” with the other normal network device is set as connect.

After the event determining module 130 generates new state information, the previously generated state information is read from a network status repository. The current state information and the previous state information are compared. When they are different, the event determining module 130 generates a device event corresponding to the device message collected by the network message collecting module 110. However, the method for the event determining module 130 to determine and generate the device event corresponding to the device message is not limited to the above-mentioned example. Moreover, when the two pieces of state information are different, the event determining module 130 stores the state information into the network status repository as the previous state information next time.

The database 140 records the device events. The database 140 also stores the display attributes of the network devices in the network environment 400. For example, the attributes include the image file of the network device, the display coordinates for the network device to be displayed at the reproducing client 210, the coordinates displayed in linking, etc. The invention, however, is not limited to these examples.

The server transmission module 150 receives the network state request sent from the reproducing client 210, and returns the device event corresponding to the network state request to the reproducing client 210. The network state request received by the server transmission module 150 includes at least an initial time for reproducing the network topological change. If the network state request further includes an ending time for reproducing the network topological change, then it means that the reproducing client 210 requests for the change in the network topology within a certain period (initial time to ending time). If the network state request does not include the ending time, it means that the reproducing client 210 request the network topology change from the initial time to the current time.

The server transmission module 150 also transmits the display attributes corresponding to the network devices in the network environment 400. The server transmission module 150 can add the display attributes of the network devices into the reproducing data of the device event. Thus, the display attributes of the network devices are sent to the reproducing client 210 along with the device event.

The data searching module 160 searches in the database 140 for a device event according to the network state request received by the server transmission module 150, and returns the device event to the reproducing client 210 via the server transmission module 150. The network state request received by the server transmission module 150 may include a specific time or code for the data searching module 160 to search for the device event. When the network state request includes a specific time, the data searching module 160 uses it to search for a device event with the same event time in the database 140. When the network state request includes a specific code, the data searching module 160 uses it to search for a device event with the same event code in the database 140.

In general, the device event satisfying the specific time/code contained in the network state request is the one whose event time/code is the same as or later/greater than the specific time/code contained in the network state request. However, the invention is not limited to this possibility. That is, there may be one or more device events found by the data searching module 160 from the database 140. Besides, if the network state request does not include a specific time and code, then the data searching module 160 searches for all the device events stored in the database 140.

Moreover, suppose the reproducing data contained in the first device event found by the event searching module 160 are not the complete state information of the network environment 400, but the difference data between two device events (the device event found by the event searching module and its previous device event). According to the order of event time recorded in the device events, the device event with the complete state information of the network environment 400 and having the event time closest to the first found device event, hereinafter referred to as the checkpoint device event, is searched for. The server 100 may further include an information generating module 180. The information generating module 180 uses in sequence the difference information contained in the device events whose event time is latter than the checkpoint device event to update the complete state information of the network environment 400 contained in the checkpoint device event, until the first found device event is used. Therefore, the complete state information of the network environment 400 at the time of the first found device event can be constructed. The state information thus generated is then used as the reproducing data of the first device event found by the event searching module 160. The server transmission module 150 then transmits the complete state information of the network environment 400 to the reproducing client 210.

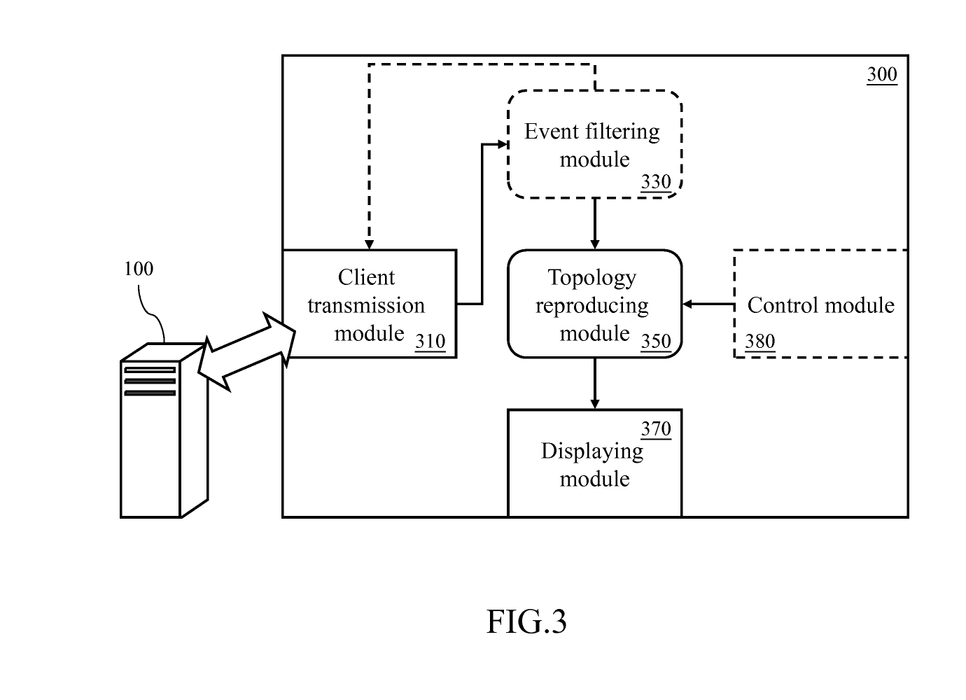

The following describes the operation of the reproducing client 210. As shown in FIG. 1, the reproducing client 210 connects with the server 100. The reproducing client 210 executes client software 300 with network management functions. The client software 300 can visually reproduce the change in the network topology of the network environment 400 within a period of time and the change in the device states of the network devices 401, 402, 403. The client software 300, as shown in FIG. 3, further includes a client transmission module 310, a topology reproducing module 350, and a displaying module 370.

Following the user's operation, the client transmission module 310 sends the network state request to the server 100 and receives one or more device events returned from the server 100 according to the network state request.

The topology reproducing module 350 defines the display data of the network devices in the network environment 400 when the device event occurs according to the reproducing data in the device event. The display data defined by the topology reproducing module 350 include the linking states of the network devices in the network environment 400. They may even include the device states of the network devices. However, the invention does not impose any restriction on the display data.

If the client transmission module 310 receives several device events, the topology reproducing module 350 defines the display data for each of the device events. If the reproducing data in the device event is the complete state information of the network environment 400, then the topology reproducing module 350 can define the display data of the network devices in the network environment 400 when the device event happens directly according to the reproducing data. If the reproducing data in the device event is the difference between two consecutive device events (between one device event and its previous one after the device events are ordered according to the event time). The topology reproducing module 350 also adjusts the display data of the previous device event for all of the network devices in the network environment 400 according to the difference data, thereby defining the display data of the network devices in the network environment 400 when the device event happens.

Besides, when the reproducing data contained in the device event received by the client transmission module 310 further include the display attributes of the network devices in the network environment 400, the topology reproducing module 350 can define the display icons and positions of the network devices in the network environment 400 accordingly.

The displaying module 370 uses a GUI to display the display data defined by the topology reproducing module 350, showing the linking states (or event device states) of the network devices in the network environment 400 when the device event happens.

When the client transmission module 310 receives multiple device events, the displaying module 370 can display in sequence the linking states (and device states) of the network devices in the network environment 400 when each of the device events happens, thereby dynamically updating and displaying the change in the network topology of the network environment 400. The displaying module 370 can update and display the change in the network topology of the network environment 400 according to the order of the event code of the event information contained in the device event at a specific time interval. That is, the displaying module 370 can use a specific frequency to display the change in the network topology of the network environment 400. For example, it can display the linking states (and device states) of the network devices when a device event happens at the interval of one second. This dynamically displays the change in the network topology of the network environment 400.

It should be mentioned that the displaying module 370 can update the change in the network topology of the network environment 400 in time flow. When the time in the time flow matches the event time of the event information contained in the device event, the displaying module 370 then shows the linking states (and device states) of the network devices when the device event happens. For example, suppose the displaying module 370 needs to show the change in the network topology between 2:08 and 4:13. Let one second in the real world represents one minute in the time flow. Then the displaying module 370 starts by showing the network topology at 2:08. At the next second, the displaying module 370 shows the network topology at 2:09, and so on. Suppose the event time of the event information contained in some device event is 3:28. Then when the device even happens, the linking states (and device states) of all the network devices will be displayed by the displaying module 370 at the 80th second since the displaying module 370 starts to show the network topology. In this way, the displaying module 370 can also show the change in the network topology of the network environment 400.

Furthermore, the displaying module 370 can also show partial contents in the event information of the device event received by the client transmission module 310. For example, only the event type or event state is displayed. The invention, however, is not limited to such possibilities.

In practice, the reproducing client 210 can further contain a control module 380 and an event filtering module 330.

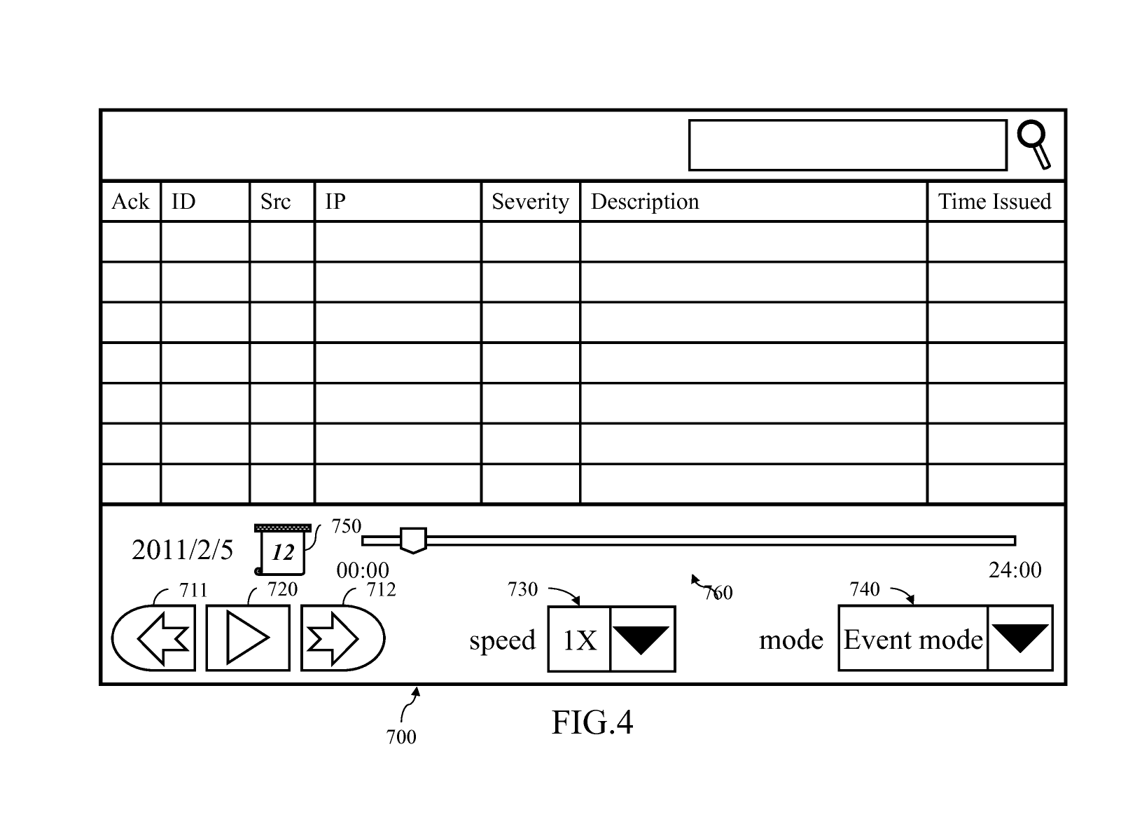

The control module 380 provides the input of a control signal so that the displaying module 370 follows the control signal to update and display the topological change in the NET 400. The control module 380 can provide a control panel 700 as shown in FIG. 4 for the user to operate and enter a control signal. The control panel 700 includes event selection buttons 711, 712, a play button 720, a speed menu 730, a play mode menu 740, a date selection button 750, and a time axis 760. The user can use them to enter an event selection signal, a play signal, a speed control signal, a mode switch signal, and a time setting signal, respectively. It should be emphasized that the control objects on the control panels are not limited to the above examples. The positions of the control objects are not restricted to the example in FIG. 4.

The event filtering module 330 provides the input of a filtering condition and uses the filtering condition to filter the event information of the device event received by the client transmission module 310. The topology reproducing module 350 only uses the device event filtered by the event filtering module 330 to define the display data of the network devices in the network environment 400. Or the displaying module is made not to display all the display data defined by the topology reproducing module 350, but only the display data defined by the device event filtered by the event filtering module.

After providing the filtering condition, the event filtering module 330 can also send the filtering condition to the server 100 via the client transmission module 310. After the server 100 returns a device event satisfying the received filtering condition to the client transmission module 310, the device event is provided to the topology reproducing module 350. The topology reproducing module 350 then defines the display data of the network devices in the network environment 400 according to the device event received by the client transmission module 310.

In the disclosed network structure, there can further include a monitoring client 220. The monitoring client 220 receives the device event transmitted by the server 100, and displays in the GUI in real time the linking states of the network devices in the network environment 400 according to the received device event when it happens. The user can thus monitor the change in the network topology of the network environment 400. The device event received by the monitoring client 220 is transmitted by the server 100 in real time after it is produced.

The monitoring client 220 also allows the user to set the display attributes of the network devices in the network environment 400 in the GUI that monitors the change in the network topology of the network environment 400. For example, one can move or change the display icon of a network device in the GUI. After the display attributes of the network devices are set, the monitoring client 220 can transmit the defined display attributes of the network devices to the server 100. The server 100 then stores the newly set display attributes of the network devices. After the display attributes of each of the network devices are transmitted to the reproducing client 210, the displaying module 370 can show the display icon of each of the network devices according to the corresponding display attributes. Hence, the displayed network topology of the network environment will be the same as the network topology of the network environment seen by the monitoring client 220 for the time when the device event is produced.

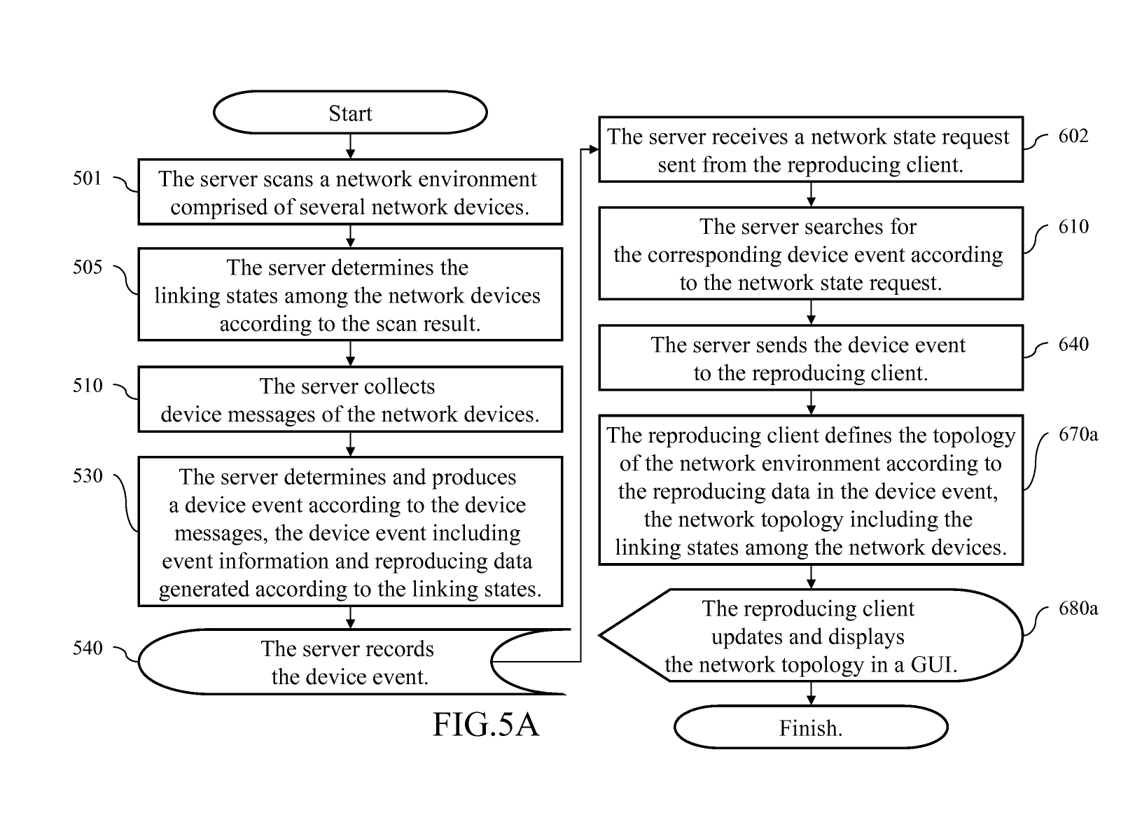

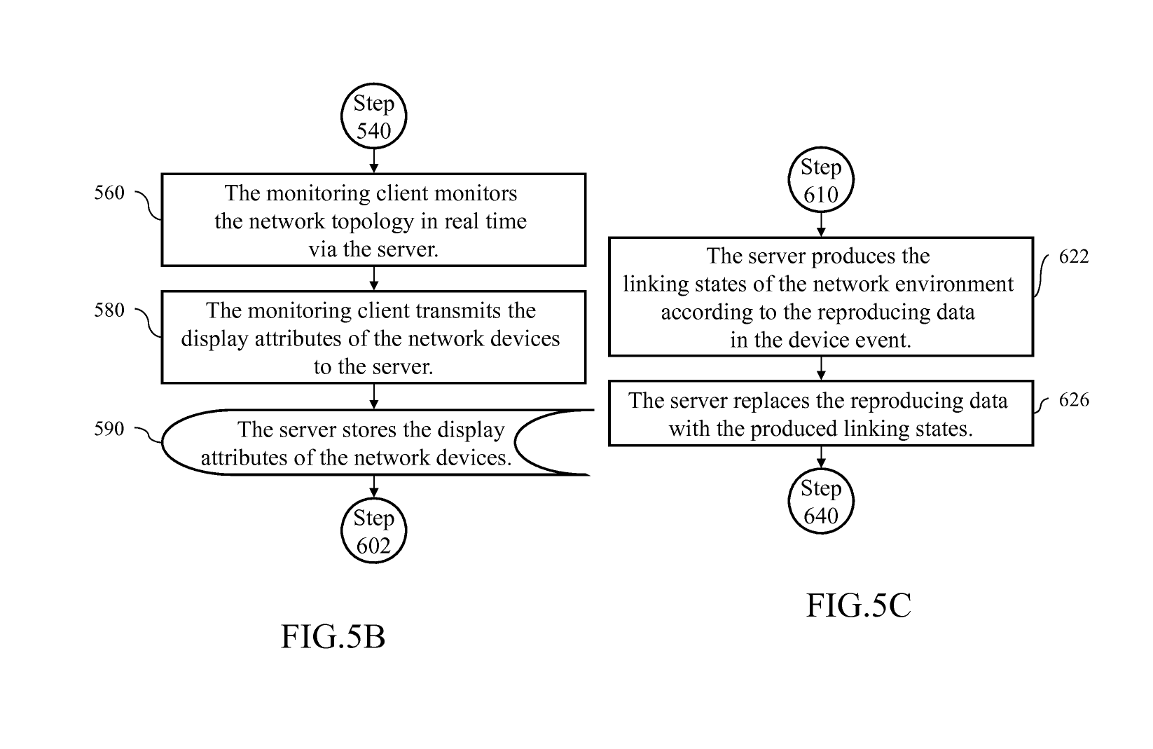

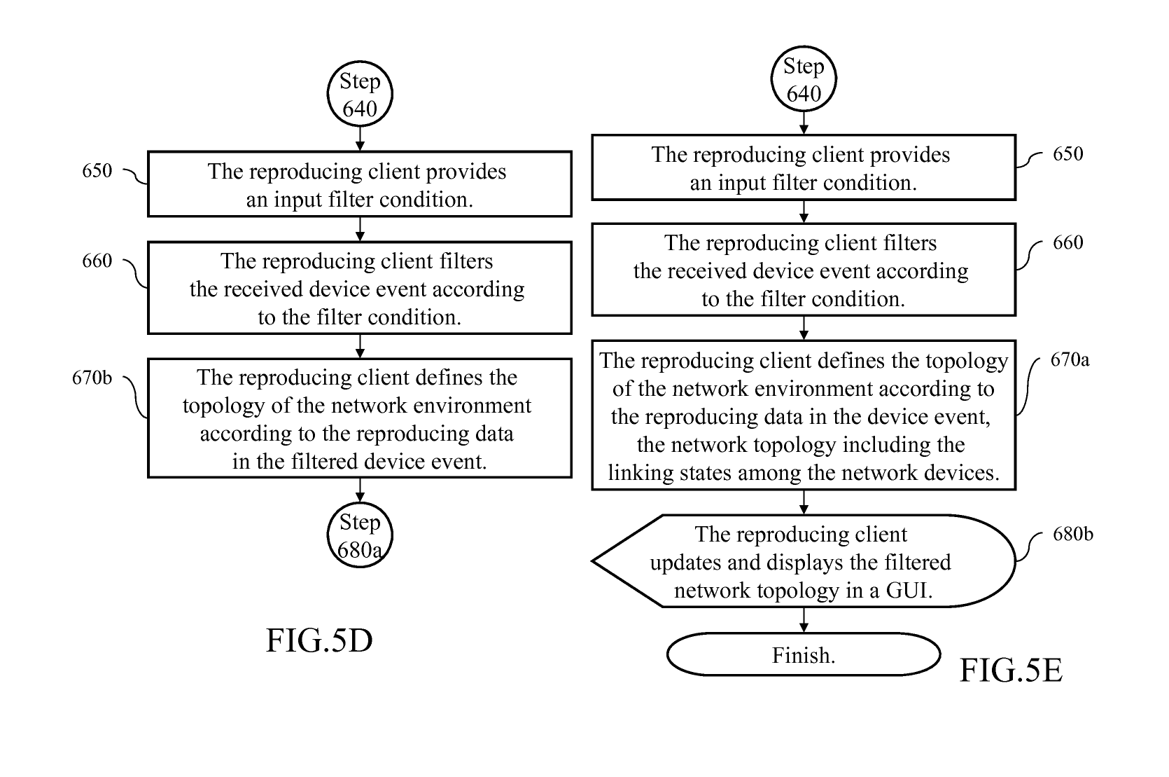

The following uses one embodiment to explain the disclosed system and method. Please refer to FIG. 5A for the flowchart of the disclosed method for reproducing topological change using device events.

First, the network message collecting module 110 in the server 100 of the invention scans the network environment 400 connected to the server 100 (step 501). The topology building module 120 in the server 100 determines the linking states of the network devices 401, 402, 403, . . . in the network environment 400 according to the scan result of the network message collecting module 110 (step 505). In this embodiment, suppose the network environment 400 is as shown in FIG. 1. The network device 402 is connected with the network device 401 and the network device 403. The IP addresses of the network devices 401, 402, 403 are respectively 192.168.127.106, 192.168.127.12, and 192.168.127.188. The second port of the network device 402 is connected with the fourth port of the network device 401. The sixth port of the network device 402 is connected with the eighth port of the network device 403.

When the connection between the network device 402 and the network device 403 breaks, the network message collecting module 110 of the server 100 will collect the device message about the broken connection with the fourth port of the network device 402 and/or the device message about the broken connection with the eighth port of the network device 403 (step 510). In this embodiment, the network message collecting module 110 can actively use the SNMP to poll the network device 402 and/or the network device 403 to obtain the device message(s). Alternatively, it can passively wait for the device message(s) sent from the network device 402 and/or the network device 403 using the SNMP.

After the network message collecting module 110 of the server 100 collects the device message (step 510), the event determining module 130 of the server 100 follows the device message collected by the network message collecting module 110 to determine and generate a device event (step 530). In this embodiment, after the event determining module 130 determines that the device message collected by the network message collecting module 110 is the device message of “Port Down” representing the interruption of connection to a specific port, the device event is generated.

Since the device event include event information and reproducing data, the event determining module 130 needs to generate the event information of the device event. The event information includes the event time, the IP address of the network device generating the device message, the event determining source, the port number of the network device, and the event state. For example, the event time is 2011/5/20 11:29:02, the IP address of the network device that generates the device message is 192.168.127.12/192.168.127.188, the event determining source is SNMP Trap or SNMP Request, the port number of the network device is 6/8, and the event state is Port 6/8 Link Down. However, the event information is not limited to the above-mentioned example.

Besides, the event determining module 130 also generates the reproducing data contained in the device event according to the linking states of the network devices 401, 402, 403 determined by the topology building module 120 of the server 100 and the device message collected by the network message collecting module 110. The event determining module 130 learns the connections to the sixth port of the network device 402 and the eighth port of the network device 403 from the linking states of the network devices 401, 402, 403 determined by the topology building module 120 of the server 100. When the device message means that the connection with the sixth port of the network device 402 breaks or the connection with the eighth port of the network device 403 breaks, the event determining module 130 determines that the connections with the sixth port of the network device 402 and the eighth port of the network device 403 are broken. Therefore, the reproducing data produced by the event determining module 130 only represent the data about the broken connections with the sixth port of the network device 402 and the eighth port of the network device 403; i.e., only the difference data.

After the connections with the sixth port of the network device 402 and the eighth port of the network device 403 are broken, the event determining module 130 also updates the linking states determined by the topology building module 120 to have broken links with the sixth port of the network device 402 and the eighth port of the network device 403. Afterwards, the complete linking states of all the network devices in the network environment 400 are recorded as the reproducing data.

After the event determining module 130 determines that the device message collected by the network message collecting module 110 is “Device Unreachable,” means that the network device 402 cannot function normally, it can also generate a device event including event information and reproducing data. For example, in the produced device event, the event information has the event time 2011/5/20 13:46:24, the IP address of the network device that generates the device message is 192.168.127.12, the event state is ICMP unreachable, and so on. Besides, the event determining module 130 can also learn that the network device 402 uses at least the second port to connect with the network device 401 and the sixth port to connect with the network device 403 from the linking states of the network devices 401, 402, 403 determined by the topology building module 120 of the server 100. When the device message means the failure of the network device 402, the event determining module 130 can determine the links between the network device 402 and the network devices 401, 403 are broken. It further updates the link states between the network device 402 and the network devices 401, 403 in the linking states determined by the topology building module 120 as broken.

In practice, to reduce the load of the server 100, the event determining module 130 thereof can compare whether the current network state of the network device is the same as the previous state of the same network device after generating the linking states of all of the network devices in the network environment 400. Only when the compared state data are different does the event determining module 130 generate a device event (step 530).

After the event determining module 130 of the server 100 generates a device event according to the device message (step 530), the database 140 in the server 100 records the device event generated by the event determining module 130 (step 540). The server 100 repeats the above-mentioned device event producing and storing procedure (steps 510 to 540) to continuously record changes in the network topology of the network environment 400.

Suppose the network structure in this embodiment includes the monitoring client 220. When the server 100 continuously records changes in the network topology of the network environment 400, as shown in the procedure in FIG. 5B, the server transmission module 150 in the server 100 also transmits the device event generated by the event determining module 130 of the server 100 to the monitoring client 220, so that the monitoring client 220 can monitor the network topology of the network environment 400 via the server 100 in real time (step 560). During the process of monitoring the network topology of the network environment 400 from the monitoring client 220, if the user operates the monitoring client 220 to set the display icon representing a particular network device in the network environment 400 and/or the display attributes (position of the display icon) thereof, the monitoring client 220 can transmit the display attributes set by the user to the server 100 (step 580). After the server transmission module 150 of the server 100 receives the display attributes of the network devices transmitted from the monitoring client 220, the database 140 of the server 100 can store the display attributes received by the server transmission module 150.

If the user wants to observe the changes in the network topology of the network environment 400 for a period of time, he/she can execute the reproducing client 210 of the disclosed client software 300. The client transmission module 310 of the client software 300 can transmit the network state request to the server 100.

After the server transmission module 150 of the server 100 receives the network state request transmitted from the client software 300 via the reproducing client 210 (step 602), the data searching module 160 of the server 100 searches the database 140 of the server 100 for a corresponding device event (step 610). In this embodiment, suppose the network state request includes a period of time, such as 2011/5/20 09:09:00 to 2011/5/20 13:14:00. The data searching module 160 finds from the database 140 all the device events whose event time falls in the time period of the network state request. The device events found by the data searching module 160 include at least the one with linking states of the network environment 400 at 2011/5/20 09:09:00 and the one with the event time of 2011/5/20 11:29:02 and representing the broken links between the sixth port of the network device 402 and the eighth port of the network device 403. The reproducing data in the device event representing the broken links between the sixth port of the network device 402 and the eighth port of the network device 403 may be the complete linking states of the network environment 400 or just the difference data representing the broken links between the sixth port of the network device 402 and the eighth port of the network device 403.

After the data searching module 160 of the server 100 finds the device events corresponding to the network state request (step 610), the server transmission module 150 of the server 100 sends the device events thus found to the reproducing client 210 (step 640). Moreover, if the reproducing data in the device event found by the data searching module 160 is not the complete state information of the network environment 400, but the difference data between two consecutive device events (the found device event and its previous device event), then the information generating module 180 of the server 100 can search for the reproducing data that contain the complete state information of the network environment 400 according to the order of the event time recorded in the device event after the data searching module 160 finds the corresponding device event (step 610). The device event with the event time closest to the first found device event is defined as the checkpoint device event. The difference data (reproducing data) in the other device events with event time later than that of the checkpoint device event are used in sequence to update the complete state information of the network environment 400 contained in the checkpoint device event, until the first found device event is used for the update. Therefore, the information generating module 180 follows the procedure in FIG. 5C to generate the linking states of the network environment 400 according to the reproducing data contained in the device event (step 622), and uses the generated linking states to replace the reproducing data in the device event found by the data searching module 160 (step 626). The server transmission module 150 can thus send the device event to the reproducing client 210 (step 640).

After the client transmission module 310 executing the client software 300 in the reproducing client 210 receives the device event sent from the server 100 in response to the network state request, the topology reproducing module 350 of the client software 300 defines the network topology of the network environment 400 according to each of the device events received by the client transmission module 310 (step 670a), i.e., defining the linking states of the network devices in the network environment 400. In this embodiment, the topology reproducing module 350 can use the reproducing data contained in the device event that represents the linking states of the network environment 400 at 2011/5/20 09:09:00 to define the network topology thereof at the time. Afterwards, if the reproducing data in the device event representing the broken link between the sixth port of the network device 402 and the eighth port of network device 403 have the complete linking states of the network environment 400, then the topology reproducing module 350 can define the network topology of the network environment 400 at 2011/5/20 11:29:02 according to the reproducing data in the device event. If the reproducing data in the device event representing the broken link between the sixth port of the network device 402 and the eighth port of network device 403 have only the difference data between the device event and the previous device, then the topology reproducing module 350 has to use the difference data to modify the network topology defined by the topology reproducing module 350 for the network environment 400 at 2011/5/20 09:09:00, thereby constructing the network topology of the network environment 400 at 2011/5/20 11:29:02 when the link between sixth port of the network device 402 and the eighth port of network device 403 is broken.

When the topology reproducing module 350 of the client software 300 defines the network topology of the network environment 400 according to the reproducing data of the device event (step 670a), if the reproducing data contain the display attributes of all the network devices therein, such as the display icon and/or the position thereof, then the topology reproducing module 350 also defines the position of the display icon of each of the network devices in the GUI according to the display attributes thereof.

After the topology reproducing module 350 of the client software 300 defines the network topology of the network environment 400 according to the reproducing data in the device event (step 670a), the displaying module 370 of the client software 300 can update in the GUI the network topology of the network environment 400 displayed on the reproducing client 210 (step 680a).

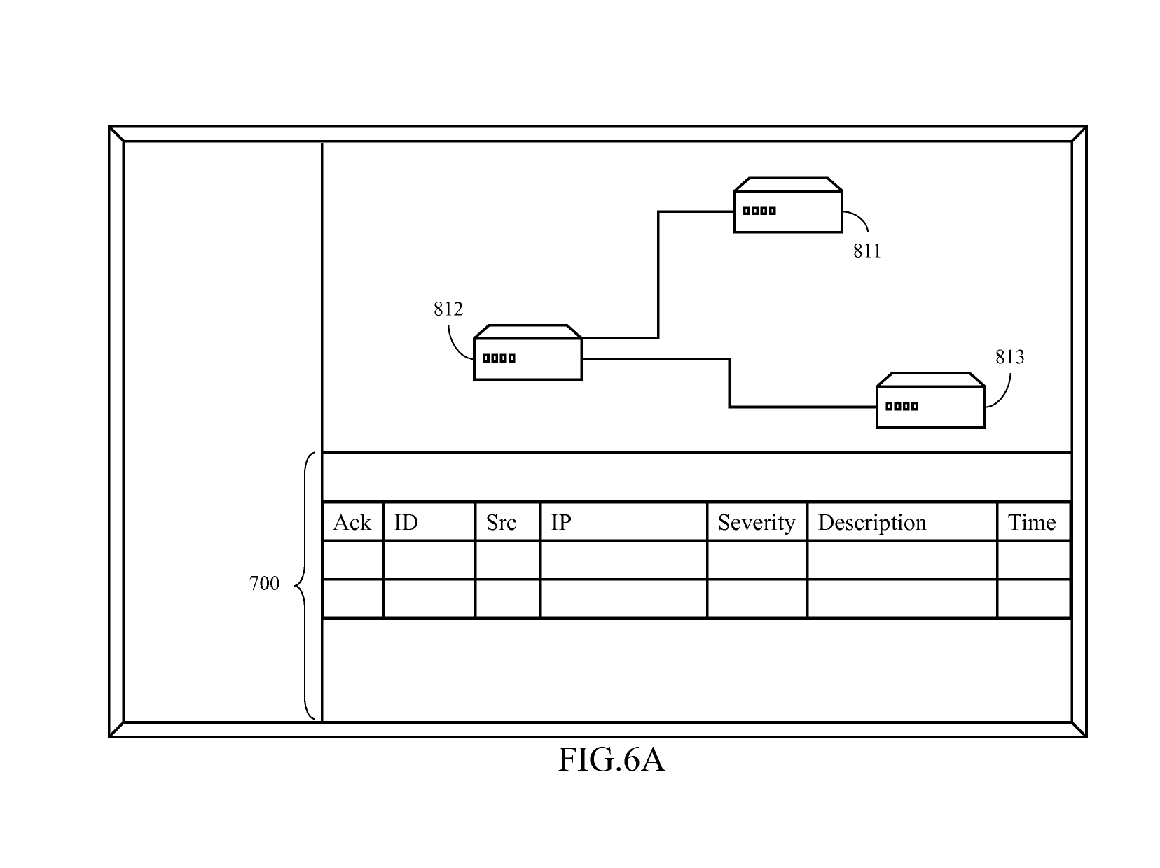

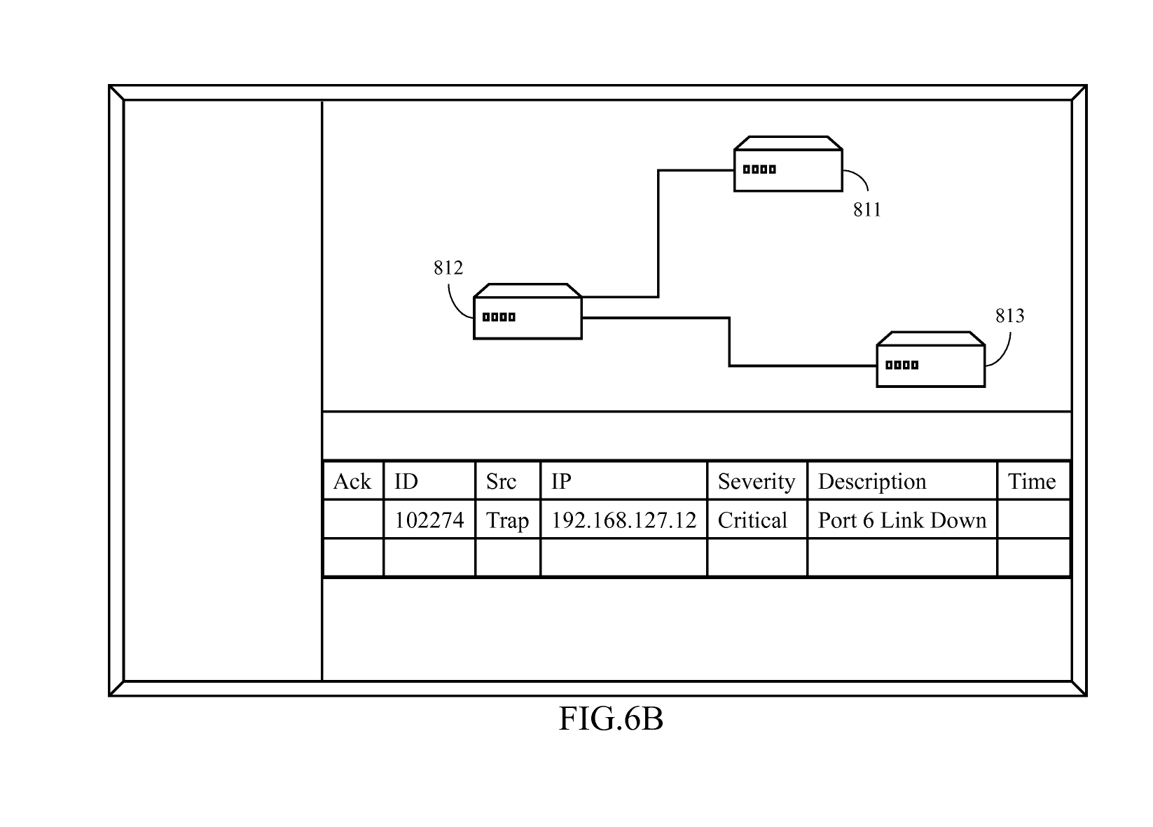

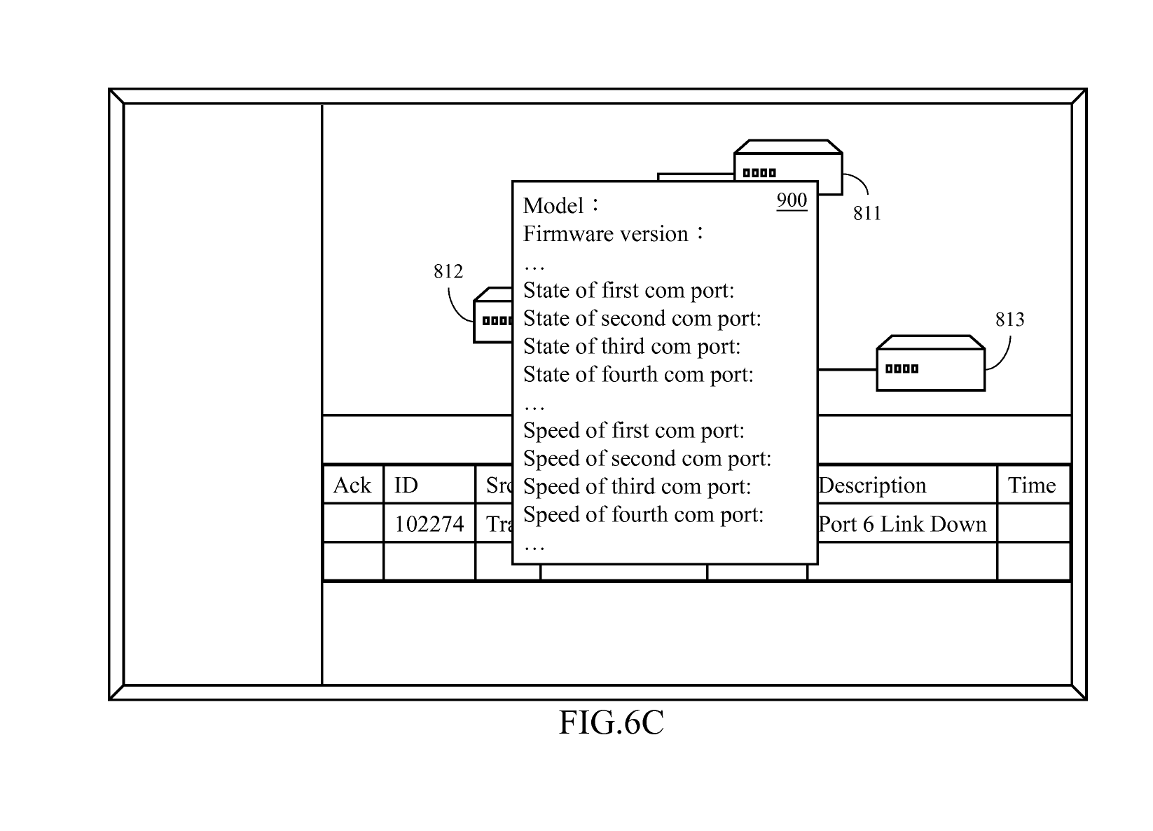

In this embodiment, suppose the displaying module 370 uses a specific frequency to display the change in the network topology of the network environment 400. For example, the network topology when a device event happens is displayed every 3 seconds. Then the displaying module 370 first shows the network topology of the network environment 400 at 2011/5/20 09:09:00, as shown in FIG. 6A. In the drawing, the display icons 811, 812, 813 represent respectively the network devices 401, 402, 403. The link between one display icon and another is represented the connection between the two corresponding network devices. After 3 seconds, the displaying module 370 updates the network topology of the network environment 400 at 2011/5/20 11:29:02, as shown in FIG. 6B. Therefore, the user can observe the topological change of the network environment 400 between 2011/5/20 9:9 and 13:14 on the reproducing client 210 in a visual way.

If the displaying module 370 displays the change in the network topology of the network environment 400 in a time flow method, e.g. every 3 seconds mean one minute in the real world, then the displaying module 370 first displays the network topology of the network environment 400 at 2011/5/20 09:09:00, as shown in FIG. 6A. Afterwards, the time of the network topology of the network environment 400 displayed by the displaying module 370 starts to flow. When the time flows to the 420.1-th second [(11:29:02−9:9:00)/60*3], the displaying module 370 shows the network topology of the network environment 400 at 2011/5/20 11:29:02, as shown in FIG. 6B. Afterwards, the time of the network topology of the network environment 400 displayed by the displaying module 370 keeps flowing, until 735 seconds [(13:14:00−9:9:00)/60*3] have passed.

Furthermore, as shown in FIG. 6C, the displaying module 370 can use a pop-up window 900 to provide the devices states of the network devices, such as the model of the network device, the firmware version, and the linking states and linking speeds of the ports.

If the client software 300 further includes a control module 380, then during the process of updating the network environment of the network environment 400 in the GUI by the displaying module 370 of the client software 300 (step 680a), the user can operate in the control panel 700 provided by the control module 380 so that the control module 380 generates the corresponding event selection signal, play signal, speed adjusting signal, mode switching signal, time setting signal, etc. The displaying module 370 is controlled to display in advance the network topology when the next device event is generated or redisplay the network topology when the previous device event is generated, to pause or continue updating and displaying the network topology, to change the frequency of the displaying module 370 for updating and displaying the network topology, to change to time flow or a specific frequency for the displaying module 370 to display the network topology, or to change to display the network topology of at a specific time point.

In summary, the invention differs from the prior art in that after the server generates the device event containing the reproducing data according to the collected device message, the device event is sent to the reproducing client. The reproducing client then updates and displays the change in the network topology of the network environment according to the reproducing data in the device event. The disclosed technique can solve the problem in the prior art that the topological change in the network environment is not easy to understand by text or table. The user can visually understand the change in linking states among the network devices.

Furthermore, suppose the client software 300 includes the event filtering module 330. Then the event filtering module 330 can follow the procedure in FIG. 5D to allow the user to enter the filtering condition for filtering the device events (step 650), such as “Link Down.” The event filtering module 330 can filter the device events received by the client transmission module 310 of the client software 300 (step 660) before the topology reproducing module 350 of the client software 300 defines the network topology of the network environment 400 according to the device event (step 670a). This leaves the device events with the event type or event state containing the filtering condition, i.e., the string of “Link Down.” As such, the topology reproducing module 350 uses the device event filtered by the event filtering module 330 to define the network topology of the network environment 400 (step 670b). The displaying module 370 only shows the network topology of the network environment 400 defined by the device event filtered by the event filtering module 330. The event filtering module 330 can also follow the procedure shown in FIG. 5E. After entering the filtering condition (step 650) and filtering the device events (step 660), the displaying module 370 updates the network topology of the network environment 400 defined by the device event filtered by the event filtering module 330 (step 680b).

Moreover, the disclosed method of reproducing topological change using device events can be implemented in hardware, software or their combination. It can also be implemented in a centralized way in a computer system or distributed among several interconnected computer systems.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A method for reproducing topological change using device events, comprising the steps of:
scanning a network environment comprised of a plurality of network devices by a server;
determining linking states of the network devices according to the scan result by the server;
using the server to collect a device message of at least one of the network devices;
using the server to determine and produce a device event according to the device message, the device event including event information and reproducing data generated according to the linking states;
using the server to record the device event;
using the server to receive a network state request sent from a reproducing client;
using the server to search for at least one of the device events corresponding to the network state request;
using the server to send the device events to the reproducing client;
using the reproducing client to define the network topology of the network environment according to the reproducing data of each of the device events, the network topology including the linking states among the network devices; and
using the reproducing client to updating and displaying the network topology in a graphical user interface (GUI).

2. The method for reproducing topological change using device events of claim 1, wherein the step of using the server to collect a device message of at least one of the network devices is achieved in a way that the server uses the Simple Network Management Protocol (SNMP) to actively and periodically poll the network devices to obtain the corresponding device message and/or the server passively receives the device messages sent from the network devices using the SNMP.

3. The method for reproducing topological change using device events of claim 1, wherein the step of using the server to determine and produce a device event according to the device message is such that after the linking states of the network devices are generated according to the device message, the device event is produced when the currently generated linking states of the network devices are compared to be different from the previously stored linking states thereof.

4. The method for reproducing topological change using device events of claim 1, wherein the step of using the server to search for at least one of the device events corresponding to the network state request is such that the server searches for the device event containing an event time matches a specific time in the network state request, and the step of using the reproducing client to updating and displaying the network topology in a GUI is such that the reproducing client updates and displays the change in the network topology of the network environment at the event time matching the specific time in a time flow.

5. The method for reproducing topological change using device events of claim 1, wherein the step of using the server to search for at least one of the device events corresponding to the network state request is such that the server searches for the device event containing an event code matches the specific code in the network state request, and the step of using the reproducing client to updating and displaying the network topology in a GUI is such that the reproducing client updates and displays the change in the network topology of the network environment according to the order of the event codes.

6. The method for reproducing topological change using device events of claim 1, wherein using the reproducing client to define the network topology of the network environment according to the reproducing data of each of the device events further includes the step of using the reproducing client to define the display data of each of the network devices in the GUI according to display attributes contained in the reproducing data.

7. The method for reproducing topological change using device events of claim 1 further comprising the step of using a monitoring client to monitor the network topology in real time via the server, and to transmit display attributes of the network devices to the server during the network topology monitoring so that the device event generated by the server contains the display attributes before the step of using the server to determine and produce a device event according to the device message.

8. The method for reproducing topological change using device events of claim 1, wherein the step of using the reproducing client to updating and displaying the network topology in a GUI further includes the step of using the reproducing client to allow the input of a filtering condition, using the filtering condition to filter the received device events, and displaying the network topology according to the filtered device event.

9. The method for reproducing topological change using device events of claim 1 further comprising the step of generating the linking states of the network environment according to the reproducing data contained in the device event and replacing the reproducing data with the generated linking states before the step of using the server to send the device events to the reproducing client.

10. A server for reproducing topological change using device events and allowing a reproducing client to connect, the server comprising:
a network message collecting module for scanning a network environment comprised of a plurality of network devices and obtaining a scan result and for collecting device messages of the network devices;
a topology building module for determining the linking states among the network devices according to the scan result;
an event determining module for determining and producing a device event according to the device message, the device event including event information and reproducing data generated according to the linking states;
a database for recording the device events;
a server transmission module for receiving a network state request sent from the reproducing client; and
a data searching module for finding at least one of the device events according to the network state request and using the server transmission module to send the device events to the reproducing client for the reproducing client to update and display the network topology of the network environment in a GUI according to the device events.

11. The server for reproducing topological change using device events of claim 10 further comprising an information generating module for generating the linking states of the network environment according to the reproducing data contained in the device event and replacing the reproducing data with the generated linking states.

12. The server for reproducing topological change using device events of claim 10, wherein the data searching module searches for the device events containing an event time matches a specific times in the network state request, and the reproducing client updates and displays the change in the network topology of the network environment at the event time matching the specific time in a time flow.

13. The server for reproducing topological change using device events of claim 10, wherein the data searching module searches for the device events containing an event code matches a specific code in the network state request, and the reproducing client uses the order of the event codes to update and display the change in the network topology of the network environment.

14. A system for reproducing topological change using device events applied to a client connected with a server, the system comprising:
a client transmission module for sending a network state request to the server and for receiving at least one device event returned by the server;
a topology reproducing module for defining the network topology of the network environment according to reproducing data in the device event, the network topology including the linking states of the network devices; and
a displaying module for updating and displaying the network topology in a GUI.

15. The system for reproducing topological change using device events of claim 14 further comprising a control module for allowing the input of a control signal, wherein the displaying module updates and displays change in the network topology of the network environment in the GUI according to the control signal, and the control signal is selected from the group consisting of an event selection signal, a play signal, a speed adjusting signal, a mode switching signal, and a time setting signal.

16. The system for reproducing topological change using device events of claim 14 further comprising an event filtering module for allowing the input of a filtering condition and for filtering a device event received by the client transmission module according to the filtering condition, the topology reproducing module defines the network topology of the network environment according to the filtered device event.

17. The system for reproducing topological change using device events of claim 14, wherein the reproducing data further include display attributes of the network devices, the topology reproducing module uses the display attributes of the network devices to define the display data of the network devices in the GUI.

18. The system for reproducing topological change using device events of claim 17, wherein the display attributes are generated by the monitoring client when the monitoring client monitors the network topology in real time and are sent to the server for storage.
